(19) United States
(12) Patent Application Publication
(10) Pub. No.: US 2025/0148296 A1
(43) Pub. Date: May 8, 2025

(54) FINE-TUNING AN AI MODEL

(71) Applicant: International Business Machines Corporation, Armonk, NY (US)

(72) Inventors: Aladin Djuhera, Dachau (DE); Fernando Luiz Koch, Palm Beach Gardens, FL (US); Martin Junghans, Karlsruhe (DE); Alecio Pedro Delazari Binotto, Munich (DE)

(21) Appl. No.: 18/538,271

(22) Filed: Dec. 13, 2023

(30) Foreign Application Priority Data
Nov. 8, 2023 (GB) 2317110.1

(51) Int. Cl. G06N 3/098

(52) U.S. Cl. CPC G06N 3/098

(57) ABSTRACT

Aspects of the present invention, determine, by a specific first computer system of the first computer systems, a need to fine-tune a first artificial intelligence model for performing a specific task; perform a federated learning for a set of trained second artificial intelligence models for generating a combined artificial intelligence model, the second artificial intelligence models being configured to perform the specific task, each second artificial intelligence model having a structure which is at least a substructure of the first artificial intelligence model; and use learnable parameters of the combined artificial intelligence model for fine-tuning at the specific first computer system the first artificial intelligence model.

### BACKGROUND

The present invention relates to the field of digital computer systems, and more specifically, to a method for fine-tuning an artificial intelligence model.

A radio access network (RAN) may provide access to and coordinate the management of resources across sites of a mobile telecommunication system in accordance with a protocol stack. The radio access network may provide processing resources which may, for example, be used to infer artificial intelligence (AI) models. However, there is a need to improve accuracy of AI models.

### SUMMARY

Various embodiments provide a method, computer program product, and system for fine-tuning an artificial intelligence model as described by the subject matter of the independent claims. Advantageous embodiments are described in the dependent claims. Embodiments of the present invention can be freely combined with each other if they are not mutually exclusive.

In one aspect, the invention relates to a method in a distributed system comprising first computer systems that are configured to connect to at least one second computer system of the distributed system. The method comprises: determining by a specific first computer system of the first computer systems a need to fine-tune a first artificial intelligence model for performing a specific task; performing a federated learning for a set of trained second artificial intelligence models for generating a combined artificial intelligence model, the second artificial intelligence models being configured to perform the specific task, each second artificial intelligence model having a structure that is at least a substructure of the first artificial intelligence model; and using learnable parameters of the combined artificial intelligence model for fine-tuning at the specific first computer system the first artificial intelligence model.

In one aspect the invention relates to a computer program product comprising a computer-readable storage medium having computer-readable program code embodied therewith, the computer-readable program code configured to implement the method of the above embodiment.

In one aspect the invention relates to a computer system for a distributed system comprising first computer systems that are configured to connect to at least one second computer system of the distributed system. The computer system is configured for: determining a need to fine-tune a first artificial intelligence model for performing a specific task; perform a federated learning for a set of trained second artificial intelligence models for generating a combined artificial intelligence model, the second artificial intelligence models being configured to perform the specific task, each second artificial intelligence model having a structure that is at least a substructure of the first artificial intelligence model; and using learnable parameters of the combined artificial intelligence model for fine-tuning the first artificial intelligence model

### BRIEF DESCRIPTION OF THE DRAWINGS

In the following embodiments of the invention are explained in greater detail, by way of example only, making reference to the drawings in which:

FIG. 1 is a block diagram of a wireless communication system in accordance with an embodiment of the present invention.

FIG. 2 is a flowchart of a method for fine-tuning an artificial intelligence model in a distributed system in accordance with an embodiment of the present invention.

FIGS. 3A & 3B are a diagram illustrating a method for fine-tuning an AI model in a distributed system in accordance with an embodiment of the present invention.

FIG. 4 is a diagram illustrating a method for fine-tuning an AI model in a distributed system in accordance with an embodiment of the present invention.

FIG. 5 is a computing environment in accordance with an embodiment of the present invention.

FIG. 6 depicts a cloud computing environment according to an embodiment of the present invention.

FIG. 7 depicts abstraction model layers according to an embodiment of the present invention.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The distributed system comprises the multiple first computer systems that are remotely connected to the one or more second computer systems. The one or more second computer systems may, for example, be multiple second computer systems. The first computer system may be a local computer system, e.g., accessible to users. The second computer system may not be part of the first computer system. The second computer system is remote from the first computer system. The first computer system may be configured to connect to the second computer system by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN), all or a portion of the Internet, any other communication system or systems at one or more locations or a combination thereof.

Each artificial intelligence (AI) model of the first and second artificial intelligence models may be configured to perform a task. The task may refer to a type of prediction or inference being made. The task may be based on the problem or question that is being asked and the available data. The task may, for example, be a classification task, clustering task, or a prediction task. For example, the classification task assigns data to categories, and the clustering task groups data according to similarity. The artificial intelligence model may perform the task by receiving input data, processing the input data using a set of learnable parameters, and providing an output that represents the result of the task. The learnable parameters may, for example, comprise weights and biases. The artificial intelligence model may be provided as deep neural network, transformer, or another artificial intelligence model that can perform the task. The first and second artificial intelligence models may be of various AI architectures such as convolutional neural networks (CNNs) or other AI architectures such as Transformers, Resnet, Long Short-Term Memory (LSTM) network, or an AI model that can be executed in accordance with an execution pipeline as described above. The terms “first,” or “second,” are used as labels for nouns that they precede, and do not imply any type of ordering (e.g., spatial, temporal, logical) unless explicitly defined as such.

The specific first computer system of the first computer systems may determine a need to fine-tune a first artificial intelligence model for performing a specific task. For example, the specific first computer system may be any first computer system of the first computer systems. Alternatively, the specific first computer system may be a selected first computer system, wherein the selection is performed according to a selection criterion. The selection criterion may, for example, require a user approved or selected system or a system having specific characteristics, e.g., having specific resources. The first artificial intelligence model may be a trained model that is stored in the specific first computer system. The fine-tuning may comprise (re) training the first artificial intelligence model on new data. The retraining of the first artificial intelligence model may use as starting point the values (starting values) of a subset of or all of the learnable parameters of the first artificial intelligence model, wherein the starting values are obtained from a last training of the first artificial intelligence model or obtained from another model via the transfer learning technique. Thus, the learnable parameters for which the starting values are provided may be all learnable parameters of the first artificial intelligence model. Alternatively, the learnable parameters for which the starting values are provided may be the subset of the learnable parameters of the first artificial intelligence model. In this later case, the retraining may be performed by freezing the remaining subset of parameters of the first artificial intelligence model.

The present subject matter may enable an accelerated and optimal fine-tuning of the first artificial intelligence model. For that, a set of trained second artificial intelligence models may be provided. Each second artificial intelligence model of the set of second artificial intelligence models is configured for performing that same specific task. Each second artificial intelligence model of the set of second artificial intelligence models has a structure that is at least a substructure of the first artificial intelligence model. For example, a given structure is at least a substructure of the first artificial intelligence model meaning that the given structure is the same as the structure of the first artificial intelligence model or that the given structure is a substructure of the first artificial intelligence model. The set of second artificial intelligence models may or may not have the same structure. Each second artificial intelligence model of the set of second artificial intelligence models may have a structure that enables to obtain at least the subset of the learnable weights of the first artificial intelligence model. For example, the first artificial intelligence model and the set of second artificial intelligence models may be of the same architecture. For example, if the first artificial intelligence model is a neural network, each second artificial intelligence model may comprise the same neural network structure or comprise part of the layers of the neural network.

A federated learning may be performed for the set of trained second artificial intelligence models for generating a combined artificial intelligence model. The federated learning may comprise training the set of second artificial intelligence models each using its own dataset. In addition, parameters (e.g., the weights and biases of a deep neural network) may be combined to generate a global model. Federated learning may enable building a common, robust machine learning model without sharing data, thus addressing critical issues such as data privacy, data security, data access rights, and access to heterogeneous data. In one example implementation of the federated learning, each of the set of second artificial intelligence models may be trained in order to obtain respective individual learnable parameters and a weighted averaging of the individual learnable parameters may be performed in order to obtain the combined artificial intelligence model.

In one example implementation of the federated learning, the federated learning may be performed at the specific first computer system, e.g., the whole set of second artificial intelligence models may be provided at the specific computer system. Alternatively, the set of second artificial intelligence models may be stored in respective second computer systems. In this case, these second computer systems may be controlled by the specific first computer system to perform the federated learning. Alternatively, the training of at least one second artificial intelligence model in the context of the federated learning may be split over multiple systems including one or more first computer systems and/or one or more second computer systems (e.g., split into cloud-edge or into edge nodes) by splitting the second artificial intelligence model into blocks and distributing the blocks over the multiple systems. The splitting may be performed as follows. The second artificial intelligence model may be configured to receive a specific input, process the specific input, and provide a specific output, and is configured to be split into a set of one or more input blocks, an intermediate block, and a set of one or more output blocks, such that the set of one or more input blocks receive the specific input and provides an intermediate output, the intermediate block receives as input the intermediate output and provides another intermediate output, and the set of one or more output blocks receive as input the other intermediate output and provides said specific output. The resulting combined artificial intelligence model may be received at the specific first computer system.

The learnable parameters of the combined artificial intelligence model may be used as starting point for fine-tuning, at the specific first computer system, the first artificial intelligence model.

According to one example, the specific first computer system may send to the second computer system a request for accelerating the fine-tuning of the first artificial intelligence model. The request may comprise a description of the first artificial intelligence model. The description of the first artificial intelligence model may, for example, comprise values of model attributes that are evaluated for the first artificial intelligence model. In response to the request, the second computer system may select the set of second artificial intelligence models using the description of the first artificial intelligence model. In one example implementation, the second computer system may send the set of second artificial intelligence models to the specific first computer system. In one example implementation, the second computer system may control the federated learning of the set of second artificial intelligence models in order to generate the combined artificial intelligence model, and then send the combined artificial intelligence model to the specific first computer system.

In one example, the set of second artificial intelligence models may be all AIs that are present in the system, wherein all the AIs may be configured to perform the same specific task. This may be advantageous as there may be no need to perform a selection. Alternatively, according to one example, the method further comprises selecting the set of second artificial intelligence models from a larger set of second artificial intelligence models based on the specific task. For example, the larger set of second artificial intelligence models may be configured to perform the specific task and one or more further tasks. This example may enable the use of different sources of artificial intelligence models. The selection may also enable obtaining suitable AI models that can further accelerate the fine-tuning.

According to one example, the set of second artificial intelligence models are a subset of a larger set of second artificial intelligence models, wherein the second artificial intelligence models can be described by model attributes. The method further comprises evaluating the model attributes for the larger set of second artificial intelligence models and storing, in a database, records representing the larger set of second artificial intelligence models, wherein the records comprise the evaluated model attributes. The database may be indexed using one or more of the model attributes, resulting in an index. The index and the specific task may be used for identifying the set of trained second artificial intelligence models. This example may enable further acceleration of the fine-tuning by using the database as a single source of all second artificial intelligence models.

According to one example, the evaluation and the storage of the model attributes are performed regularly on a periodic basis. This may enable the maintaining of an up-to-date database of models. This may enable accurate and reliable fine-tuning of the first artificial intelligence model.

According to one example, the method further comprises logging changes to the database in a log file, using the log file for tracking changes to the database, and using the index based on the tracked changes. For example, the logging may indicate a set of features and optionally performance metrics that may show a “timeline” of the model. For example, client A has a model A and client B has a model B. At some point, client A may merge model A with model B, e.g., via federated learning, resulting in new model A′. This way, the logging would indicate a new model A′ to the database. For example, the original model A may be suitable or good for a task C but model A′ is not so good anymore at task C. Thus, if the specific task is task C, the model A may be selected instead of its (new version) model A′ using the log file. Thus, the logging may provide every model architecture at any time such that the search of the models may be performed.

According to one example, using the index comprises: evaluating at least part of the model attributes for the first artificial intelligence model, defining a query based on the evaluated model attributes, querying the database using the index and the defined query, receiving a response of the query comprising candidate second artificial intelligence models, and selecting the set of trained second artificial intelligence models from the candidate second artificial intelligence models using a selection criterion. This example may enable a systematic approach for obtaining the set of second artificial intelligence models. This may further accelerate the fine-tuning by using the database as a single source of all second artificial intelligence models and predefined queries.

According to one example, the candidate second artificial intelligence models have a matching level with the defined query that is higher than a minimum threshold. This may enable controlling the level of similarity between the second artificial intelligence models and the first artificial intelligence model. In one example implementation, model attributes of the first artificial intelligence model may be compared with respective model attributes of the candidate second artificial intelligence model resulting in individual matching levels. The individual matching levels may be combined (e.g., summed or averaged) in order to obtain the matching level between the compared first artificial intelligence model and the candidate second artificial intelligence model.

According to one example, the minimum threshold is defined by the specific first computer system. This may enable the first computer system to control the fine-tuning through the control of the matching process. For example, the specific first computer system may be configured to set the minimum threshold to a desired value and then send it to the second computer system that performs the selection of the set of second artificial intelligence models.

According to one example, the selection criterion requires an inference accuracy of the candidate second artificial intelligence model that is better than an accuracy threshold.

According to one example, the federated learning is performed by aggregating learnable parameters of the set of second artificial intelligence models.

According to one example, the aggregation is a weighted sum, wherein the weights are inference accuracies of the set of second artificial intelligence models respectively. This may improve the accuracy of the fine-tuned first artificial intelligence model as it is based on weights that provide improved inference accuracies.

According to one example, the distributed system is a wireless communication system, wherein the first computer systems are multi-access edge computing (MEC) nodes and the second computer system is a cloud system. The second computer system may be part of a public cloud, private cloud, or a hybrid cloud. For example, multiple public clouds, private clouds, and hybrid clouds may be provided, wherein each of the clouds may provide resources for a second computer system (e.g., the cloud may provide the second computer system as a virtual machine). The multiple clouds may be provided by a same cloud service provider or by different cloud service providers.

According to one example, the first artificial intelligence model may be a neural network (e.g., deep neural network), a transformer, or any other artificial intelligence model and corresponding architecture (e.g., in terms of parallelization, distribution) that can be used for performing tasks such as the specific task.

According to one example, the first computer system has an amount of processing resources that is smaller than the processing resources of the second computer system. For example, the second computer system may be any computer system that has processing resources for executing the whole artificial intelligence model.

According to one example, the second computer system is provided as a service in a cloud computing environment. In one example, the second computer system may be a computer system of a Foundation Model as a Service (FMaaS) or of a Machine Learning as a Service (MLaaS) provider, wherein the first computer systems may be clients of the FMaaS or MLaaS provider. The FMaaS provider may provide FMs as services on the cloud. The MLaaS provider may provide machine learning models as services on the cloud. In one example, the second computer system may be provided as a cloud instance in the cloud computing environment. The cloud instance may be a server resource provided by cloud services. In one example, the second computer system may be implemented using one or more functional abstraction layers provided by the cloud computing environment, e.g., the hardware and software resources of the second computer system may be provided by the hardware and software layer of the cloud computing environment. The workload layer of the cloud computing environment may, for example, be used to implement the steps to be executed by the second computer system.

According to one example, the first artificial intelligence model is a foundation model. The foundation model may be a large artificial intelligence model trained on a vast quantity of data at scale resulting in a model that can be adapted to a wide range of downstream tasks. Examples of foundation models include Bidirectional Encoder Representations from Transformers (BERT) and the Generative Pre-trained Transformer n series (GPT-n series).

According to one example, the first computer system is any one of: edge device (e.g., such as a MEC node), user equipment (UE) or an internet of things (IoT) device. This example may be seamlessly integrated in wireless or mobile communication systems. The mobile communication system provides wireless connectivity to users. The users may, for example, comprise mobile devices, tablets, laptops, or individuals. The mobile communication system may comprise a radio access network (RAN) and a core network. The core network may provide Internet Protocol (IP) connectivity to the radio access network. The radio access network may manage the radio spectrum of users using radio devices such as base stations. The radio access network may enable to process packets in accordance with a processing pipeline. The processing pipeline has different layers. The layers include baseband processing layers and radio frequency (RF) processing layers. The baseband processing layers may be defined in accordance with a protocol stack and may be performed by a baseband unit, wherein the baseband unit is comprised in the edge device.

The baseband unit may be associated with one or more base stations. For example, each base station of the one or more base stations may serve users located within the base station's geographical area of service or a cell. The baseband unit may process baseband signals for served users of the one or more base stations. Thus, the baseband unit is said to be serving said users. The baseband unit may implement the layers of the protocol stack such as the Packet Data Convergence Protocol (PDCP) layer, Radio Link Control (RLC) layer, Medium Access Control (MAC) layer and Physical (PHY) layer. In one example, the baseband unit may be divided into function entities each being configured to perform a respective function, e.g., a function may implement one or more layers of the stack protocol. For example, the baseband unit may be divided into two function entities named Centralized Unit (CU) and Distributed Unit (DU). The CU may provide support for the higher layers of the protocol stack such as the PDCP layer while the DU provides support for the lower layers of the protocol stack such as the RLC, MAC, and Physical layers.

The implementation of the baseband unit may be realized with a specific hardware and software configuration of the edge device. The software configuration of the baseband unit may comprise an operating system and software modules for performing the functions of the baseband unit. In addition, the software configuration may indicate one or more vendors that provide the software configuration. For example, the operating system and software modules may be provided by one or more vendors. The hardware configuration may comprise storage resources, data communication resources, and processing resources. In addition, the hardware configuration may indicate one or more vendors that provide the hardware configuration. The resources may be provided by one or more vendors.

The present subject matter may overcome the issues of costly on-prem fine-tuning. The present subject matter may introduce adaptive and collaborative tools and methods for efficiently accelerating the initial fine-tuning process of large Foundation Models (FMs), without resorting to complete workload or sensitive data distribution to the cloud. The present subject matter may speed up the initial stages of fine-tuning which may be typically slow. Hence, expensive on-prem computations, limited availability of computing resources, and potentially redundant fine-tuning within a shared enterprise network, can be overcome. Additionally, a FMaaS provider may make efficient use of its hosted FMs and improve services and capabilities by collaboratively federating its FMs for specific use cases.

The present subject matter may advantageously be used in a distributed system having a FMaaS network, in which clients request and deploy a pre-trained FM within their respective edge networks. In this setup, the FMaaS provider may, for example, provision a FM on demand and leave the fine-tuning task to the respective client network, while at the same time retaining a copy of the eventually fine-tuned FM architecture and weights for each respective client. The retained copies may be the second artificial intelligence models. The deployed pre-trained FM may be the first artificial intelligence model. The present subject matter may systematically accelerate the process of fine-tuning when changes, such as a new classification objective, are introduced during the process. It may make use of collaborative learning techniques to leverage the learned knowledge and skills from other AIs and/or clients within the FMaaS network. It may identify fine-tuned models for potential collaboration, ensuring improved classification performance without compromising the existing inference performance.

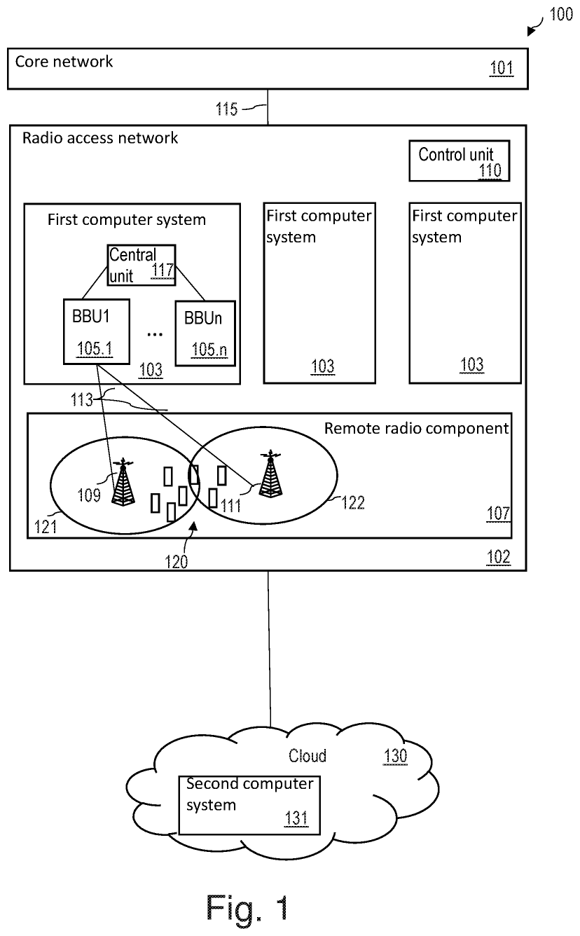

FIG. 1 depicts a diagram of a wireless communication system in accordance with an embodiment of the present invention.

The wireless communication system 100 comprises a core network 101 and a radio access network 102. The radio access network 102 may comprise a remote radio component 107 equipped by, but not limited to, base stations 109 and 111. Each base station 109 or 111 may comprise a remote radio unit (RRU) with antennas and may serve UEs 120 in respective cells 121 and 122. The radio access network 102 may further comprise first computer systems 103. For simplification of the description, only three first computer systems are shown but it is not limited to. AIso, only components of one first computer system are described for simplification of the drawings.

The first computer system 103 may, for example, comprise a set of one or more baseband units (BBUs) 105.1-n. The baseband unit may be connected to a respective RRU in the remote radio component 107 through a fiber or cable 113. The first computer system 103 may be configured to connect to the core network 101 via a backhaul link 115. The first computer system 103 may comprise a central unit 117 that is configured to control the operation and deployment of the baseband units 105.1-n. Each of the first computer systems 103 may, for example, be provided as a MEC node. The MEC nodes may improve user services (e.g., with a low latency). The first computer system 103 may, for example, process data provided by the BBUs using advanced techniques, e.g., for image analysis. The radio access network 102 may comprise a control unit 110 for managing workloads in the wireless communication system 100. Although shown as separate component, the control unit 110 may be in another example part of the one or more first computer systems 103.

The remote radio component 107 and the first computer system 103 may be configured to connect to a cloud computing environment 130. The cloud computing environment 130 may comprise at least one second computer system 131. In one example, the second computer system 131 may be provided as a cloud instance in the cloud computing environment 130.

The first computer system 103 may, for example, comprise the first artificial intelligence model and the cloud computing environment 130 may comprise second artificial intelligence models in one or more second computer systems of the cloud computing environment 130. The second artificial intelligence models may, for example, be provided by a FMaaS provider.

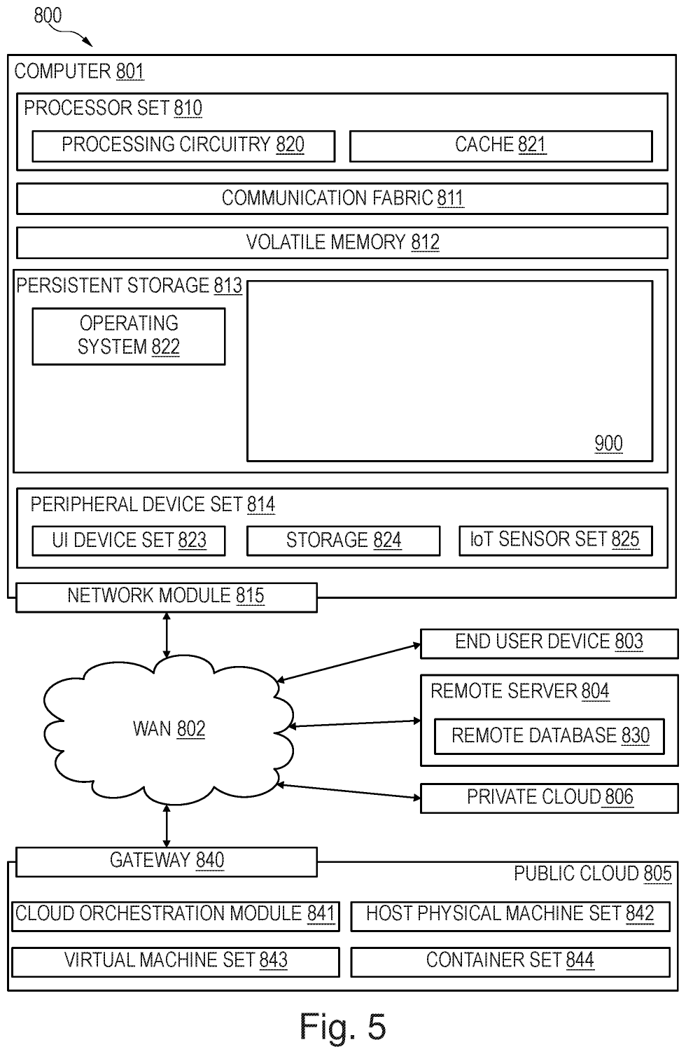

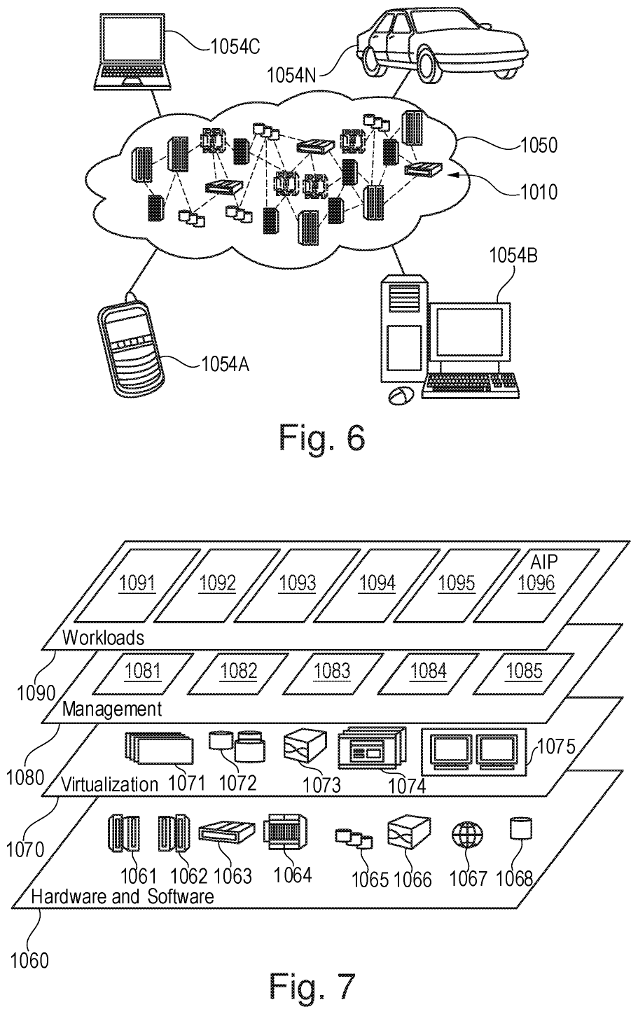

In one example implementation, the cloud computing environment 130 may, for example, be provided as described with reference to FIGS. 6 and 7. For example, the second computer system 131 may be implemented using one or more functional abstraction layers provided by the cloud computing environment 130, e.g., the hardware and software resources of the second computer system 131 may be provided by the hardware and software layer of the cloud computing environment 130. The workload layer of the cloud computing environment 130 may, for example, be used to implement the execution of the main block of the AI model by the second computer system 131.

In one example implementation, the system 100 may be provided as an Open Radio Access Network (O-RAN), where the first computer system 103 may be in one or more edge sites and the remote radio component 107 may be in one or more cell sites.

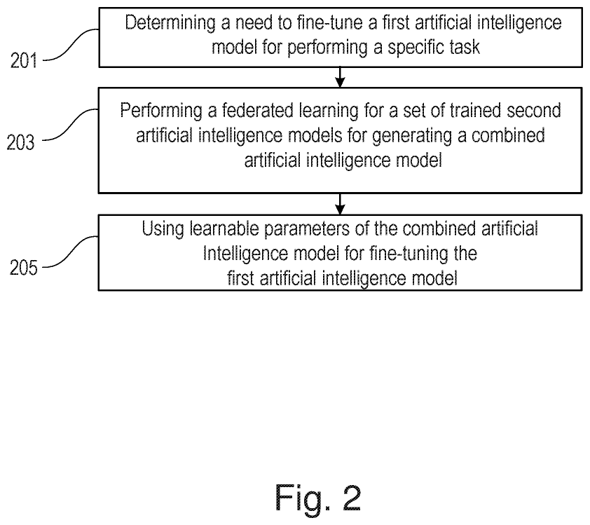

FIG. 2 is a flowchart of a method for fine-tuning an artificial intelligence model in accordance with an embodiment of the present invention.

A specific first computer system of the first computer systems may determine in step 201 a need to fine-tune a first artificial intelligence model for performing a specific task. In one example, the specific first computer system may determine the need of fine-tuning upon receiving by the specific first computer system a fine-tune request to fine-tune the first artificial intelligence model. In another example, the specific first computer system may determine the need of fine-tuning automatically by, for example, detecting that the inference accuracy of the first artificial intelligence model is worse than a desired accuracy.

A federated learning for a set of trained second artificial intelligence models may be performed in step 203. The federated learning may be performed for generating a combined artificial intelligence model. The second artificial intelligence models are configured to perform the specific task. Each second artificial intelligence model has a structure that is at least a substructure of the first artificial intelligence model.

Learnable parameters of the combined artificial intelligence model may be used in step 205 for fine-tuning at the specific first computer system the first artificial intelligence model. The fine-tuning may be defined by either the first computer system or a standardized procedure within the FMaaS guidelines. The fine-tuning may, for example, include a re-training process with a set number of epochs and a defined dataset. The fine-tuning may be a one-time process or continuous every once in a while, e.g., every n hours, every n model uses, every n data permutations, etc. The fine-tuning may follow a procedure defined by the first computer system or may follow a procedure defined by the FMaaS provider.

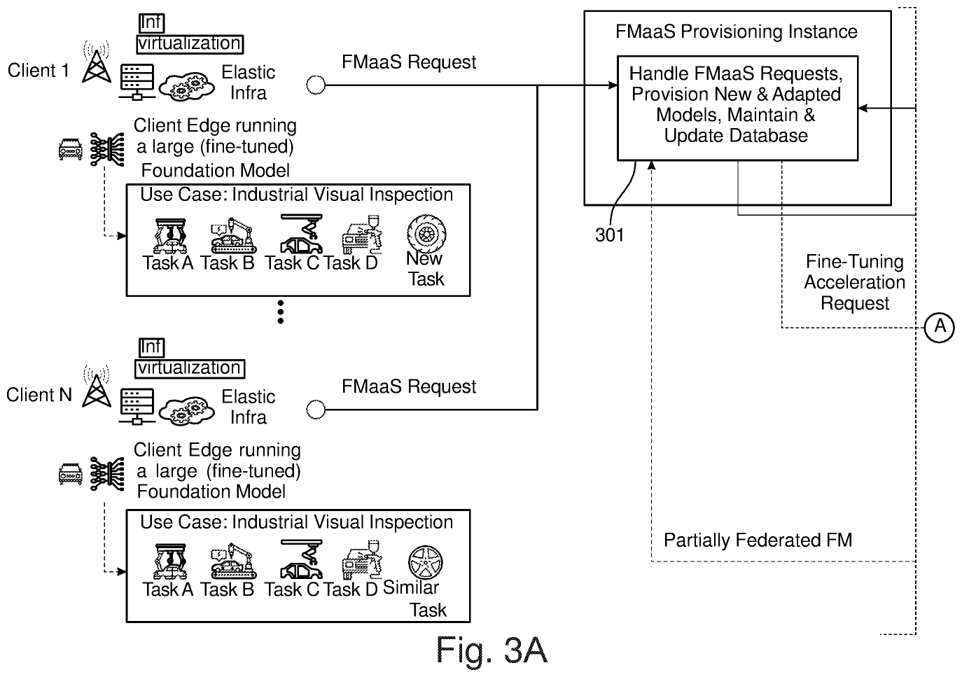

FIGS. 3A & 3B are a diagram illustrating a method for fine-tuning an AI model in a distributed system comprising multiple clients Client 1, . . . . Client N, and a cloud system of a FMaaS provider, in accordance with an embodiment of the present invention. The cloud system may comprise the database 310 and computing capabilities 311. In this use case, the FMaaS provider distributes a pre-trained FM to the multiple clients within their respective edge networks. This is indicated in FIGS. 3A & 3B where each client is associated with a FM for performing tasks such as Task A.

The FMaaS provider may provision the FM on demand and leave the fine-tuning task to the clients, while also retaining a copy of the fine-tuned FM architecture and weights for each client, respectively. For instance, the setup of FIG. 3 may be used by N distributed production facilities (original equipment manufacturers (OEM) or independent) that may not be directly sharing computational resources or data with one another. The FMaaS provider may store the FMs in the cloud, tailored to the respective inference tasks on-site. In this example, each production facility may request (301) the same or a similar class of pre-trained FMs for performing a new task, such as a vision-based model for visual inspection tasks. Fine-tuning may be necessary as the visual classification objective may be customized.

In step 303, a method for Foundation Model Tracking (FMT) may be performed. This method may provide a keyword-based functionality for managing, labelling, and searching for fine-tuned FMs within a FMaaS network. Given information about the clients' fine-tuned FM architectures, weights, available identifiers about the primary use of the model and other meta information, this method tracks, logs, and continually updates a keyword-based database 310 of provisioned fine-tuned FMs, including a copy of the respective weights.

In step 305, a method for Candidate Model Identification (CMI) may be performed. This method may identify potential candidate fine-tuned FMs that could perform well on the new classification task. Given information on the new classification task, desired augmentation capabilities of the provisioned FM, corresponding labels, and other descriptive metadata, this method provides a list of suitable candidate FMs by performing a keyword search within the FMT database 310. If no keywords are matched or information is unavailable, an external database or a randomized approach may be used instead.

In step 307, a method for Candidate Model Evaluation (CME) may be performed. This method may evaluate each candidate FM's performance on the new target classification task. Given a list of candidate fine-tuned FMs, provided by the CMI database search results, this method may securely deploy each fine-tuned FM onto a specified HW platform and evaluate its performance on the new dataset by means of assessing the inference accuracy.

In step 309, a method for Selective Model Federation (SMF) may be performed. This method may federate suitable candidate FMs to obtain a more informed initial model update to eventually continue fine-tuning on. Given the evaluation of the selected candidate FMs, provided by the CME, this method implements a weighted federated aggregation of the fine-tuned FM weights via Federated Learning (FL) in order to obtain a more robust FM and hence a significant head start for the fine-tuning process, since it contains shared knowledge of similar FMs within the connected network. The method may ensure only the most suitable candidates are selected for collaborative learning, guaranteeing improved classification performance without compromising existing inference performance.

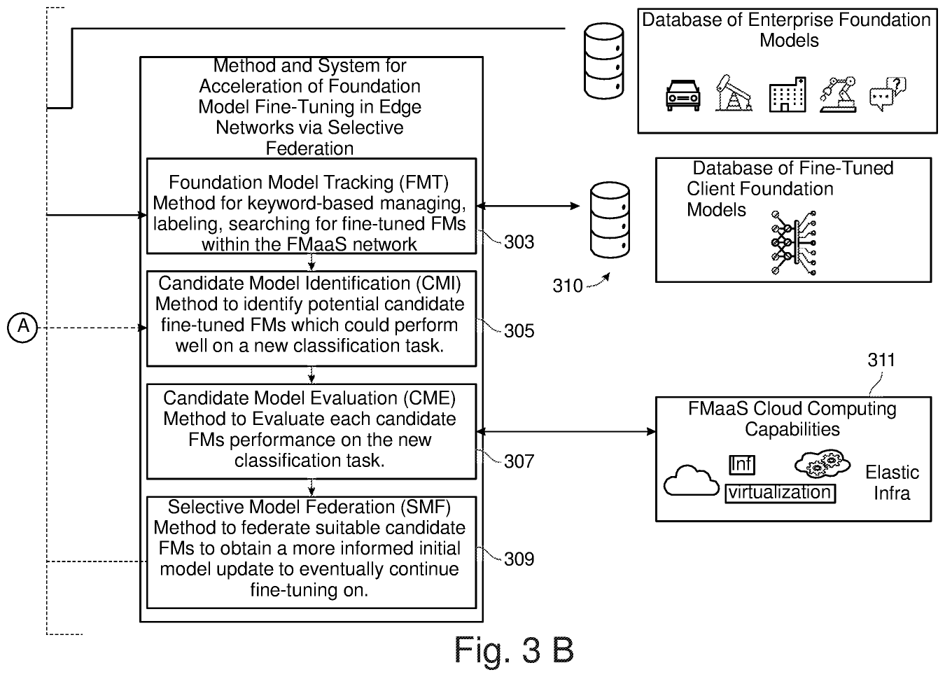

FIG. 4 depicts a diagram illustrating a method for fine-tuning a FM in accordance with an embodiment of the present invention. The method may be performed in a distributed system defined by a FMaaS provider 402 and an edge node 401. The FMaaS provider 402 may be the second computer system of the distributed system and the edge node 401 may be the first computer system of the distributed system. The edge node 401 may comprise a FM 403 to be fine-tuned. The FM 403 may, for example, be fine-tuned for performing a new task. The edge node 401 may send a request to accelerate the fine-tuning to the FMaaS provider 402. The request may include meta information and configuration data of the FM 403. The meta information and the configuration data may be used by the FMaaS to provide a description of the task of the FM 403. This description may be used by the FMaaS provider 402 to perform in step 405 a candidate model identification (CMI) for identification of candidate FMs. The CMI may be performed (406) using a FM tracking in a database 407 of FMs. The candidate FMs may be evaluated in step 409 using evaluation data 410 and computing capabilities 411 of the FMaaS provider 402. The evaluation may be performed using performance metrics. And the candidate FMs with similar target capabilities may be selected in step 413. The selected candidate FMs may be used to provide (415) a federated FM to the edge node 401. The edge node 401 may use the federated FM for fine-tuning the FM 403.

The method of FMT in step 406 may be performed as follows. The method may provide a keyword-based functionality for managing, labelling, and searching for fine-tuned FMs within a FMaaS network. A set of information elements i1) through i5) may be provided as follows: i1) a list of participating edge clients who have opted-in via a service level agreement (SLA) or other agreements; i2) information about each client's FM family (domain), i.e., which original enterprise FM has been requested and deployed via the FMaaS offering; i3) specifications about each client's fine-tuned FM parameters (including architecture and weights) for every time instance these have been adapted; i4) information about each client's primary use of the fine-tuned FM via predefined identifiers such as target domain, task, and other specifics (e.g. automotive visual inspection of airbags); and i5) all other available meta information such as model size, approximate inference time, etc. Given the information elements i1) through i5), the FMT implements a comprehensive database including all of above information and records, which are managed by parsable keywords. The created database may have the following features: a) Database Architecture: Implements in a chosen database framework, e.g., a relational database management system, important classifiers such as FM architecture, model use, meta information, etc. as registered fields with accessible payloads being the concrete FM parameters (weights); b) Keyword-Based Indexing System: Implements indexing based on above identifiers, descriptions and other available information so as to enable database parsing via these specific keywords; and c) Logging and Tracking: Implements a logging mechanism to track any updates or modifications made to the database, e.g., when a client changes its FM weights after fine-tuning for a different target objective.

The method for CMI in step 405 may be performed as follows. This method may identify potential candidate fine-tuned FMs that could perform well on a new classification task. Given information about the new classification task including the corresponding label of interest, target domain and other descriptive meta data as well as information about the previously deployed FM and given access to a parsable database of available fine-tuned FMs such as the one provided by the FMT method or equivalent (e.g., external databases such as HUGGINGFACE), then, the Candidate Model Identification implements a keyword-based search process to identify potential candidate models that could perform well on the new classification task based on their target domains and specific fine-tuning efforts. The result is a collection of candidate models. To this, a semantic parsing of a database may be performed as follows. Given information about the architecture and keyword indexing of the considered database, this method implements a parsing object (e.g., dictionary, string, etc.) that includes the classifiers of interest such as target domain, specific task, and other meta information. Using this parsing object, a successful keyword matching is defined by a threshold ratio of matches r, which denotes the minimum ratio of matches and can be pre-configured. Ideally, a positive result is returned when the ratio is higher than r. If no keywords are matched and/or no further information is available, an external database (e.g., HUGGINGFACE) can be considered. If the model to be fine-tuned differs severely in its new classification task, the client may request a reduction of r and/or a randomized selection out of all available fine-tuned FMs within the database. Eventually, the method returns a collection of candidate models including their respective architecture and weights as an extraction of the entries within the parsed database.

The method for Candidate Model Evaluation (CME) in step 409 may be performed as follows. This method may evaluate each candidate FM's performance on the new target classification task. For that, the following information elements j1) through j3) may be provided: j1) a list of candidate models to be evaluated, e.g., provided by the CMI database search results; j2) sufficient computing capabilities at either an on-prem inferencing server or an external server, e.g., a FMaaS computing instance; and j3) a threshold p of acceptable performance per evaluation result as well as a maximum number n of candidate models to be evaluated. If n is smaller than the number of available candidate models, a random draw or other techniques can be applied. Given information elements j1) through j3), the Candidate Model Evaluation method implements a pipeline to evaluate each candidate model based on the new classification task and available input data. The result is an evaluation denoting the suitability of each FM as well as its inference accuracy. If the inference is performed on a batch, the batch size's average accuracy can be used instead of the accuracy of just one sample. This method may be implemented as an inferencing pipeline by performing steps s1) through s7). In s1), the data privacy of the client may be assessed and depending on said assessment a step of the steps s2) to s5) may be performed. In s2), the inference pipeline may be implemented strictly on-prem. In s3), the inference pipeline may be implemented in hybrid via Split Inference techniques. In step s4), the inference pipeline may be implemented strictly on-server using un obfuscated data. In step s5), the inference pipeline may be implemented strictly on-server using obfuscated or surrogate data supplied by the client. In step s6), inference for each of the n candidate models may be performed and their respective inference accuracy may be noted so as to derive an evaluation vector e:

e=[{model₁; accuracy₁}, . . . , {modelₙ; accuracyₙ}]. In step s7), all entries in vector e whose accuracy is strictly below p may be discarded so as to derive the final evaluation vector e* with length (e*)<=n.

The method for Selective Model Federation (SMF) in step 413 may be performed as follows. This method may federate suitable candidate FMs to obtain a more informed initial model update to eventually continue fine-tuning on. Given the evaluation results of potential candidate FMs provided by the CME method, then, the Selective Model Federation method implements a weighted federated averaging process to aggregate the parameters of the respective fine-tuned FMs by averaging the FM parameters with weighted contributions of the K contributing models, which consist of the respective inference accuracies of the evaluation results, e.g.,

$$new params = \frac{1}{K} {\sum }_{i = 1}^{K} ( accuracy {model}_{i} \times params {model}_{i} )$$

and by distributing the new model parameters to the originating client for further fine-tuning efforts.

The method of FIG. 4 may thus enable a new classification task at the client edge such that the currently deployed FM needs to be fine-tuned to cater to the new classification objective while still being in the same family (domain) of FM inference models. Since the initial stages of on prem fine-tuning are typically slow and costly, the client edge issues a Fine-Tuning Acceleration Request to the FMaaS instance. The latter makes use of an available database of already fine-tuned models of the same family (domain) of enterprise FMs, which have been collected through an SLA between the clients and the FMaaS provider. Subsequently, the provider evaluates these fine-tuned FMs to identify those which perform well on the new classification task. In order to now provide an acceleration in fine-tuning to the requesting client party, a weighted federation of well-performing FMs is performed, after which this new set of model parameters is distributed to the requesting client who continues to fine-tune its model.

A method in a distributed system comprising first computer systems that are configured to connect to at least one second computer system of the distributed system, the method comprising: determining by a specific first computer system of the first computer systems a need to fine-tune a first artificial intelligence model for performing a specific task; performing a federated learning for a set of trained second artificial intelligence models for generating a combined artificial intelligence model, the second artificial intelligence models being configured to perform the specific task, each second artificial intelligence model having a structure which is at least a substructure of the first artificial intelligence model; using learnable parameters of the combined artificial intelligence model for fine-tuning at the specific first computer system the first artificial intelligence model.

In an embodiment, the method further comprises selecting the set of second artificial intelligence models from a larger set of second artificial intelligence models based on the specific task.

In an embodiment, the set of second artificial intelligence models is a subset of a larger set of second artificial intelligence models, wherein the second artificial intelligence models can be described by model attributes. In this embodiment, the method further comprises: evaluating the model attributes for the larger set of second artificial intelligence models; storing, in a database, records representing the larger set of second artificial intelligence models, the records comprising the evaluated model attributes; indexing the database using one or more of the model attributes, resulting in an index; and using the index and the specific task for identifying the set of trained second artificial intelligence models.

In an embodiment, the evaluation and the storage being performed regularly on a periodic basis.

In an embodiment, the method further comprises logging changes to the database in a log file, using the log file for tracking changes to the database, and using the index based on the tracked changes.

In an embodiment, using the index comprises: evaluating at least part of the model attributes for the first artificial intelligence model; defining a query based on the evaluated model attributes; querying the database using the index and the defined query; receiving a response of the query comprising candidate second artificial intelligence models; and selecting the set of trained second artificial intelligence models from the candidate second artificial intelligence models using a selection criterion.

In an embodiment, the candidate second artificial intelligence models have a matching level with the defined query that is higher than a minimum threshold.

In an embodiment, the threshold is defined by the specific first computer system.

In an embodiment, the selection criterion requires an inference accuracy of the candidate second artificial intelligence model that is better than an accuracy threshold.

In an embodiment, the federated learning is performed by aggregating learnable parameters of the set of second artificial intelligence models.

In an embodiment, the aggregation is a weighted sum, wherein the weights are inference accuracies of the set of second artificial intelligence models respectively.

In an embodiment, the first computer system has an amount of processing resources which is smaller than the processing resources of the second computer system.

In an embodiment, the distributed system is a wireless communication system, wherein the first computer systems are multi-access edge computing (MEC) nodes and the second computer system is a cloud system.

In an embodiment, each of the artificial intelligence models is a foundation model.

Computing environment 800 contains an example of an environment for the execution of at least some of the computer code involved in performing the inventive methods, such as code 900 for fine-tuning an artificial intelligence model. In addition to code 900, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and code 900, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

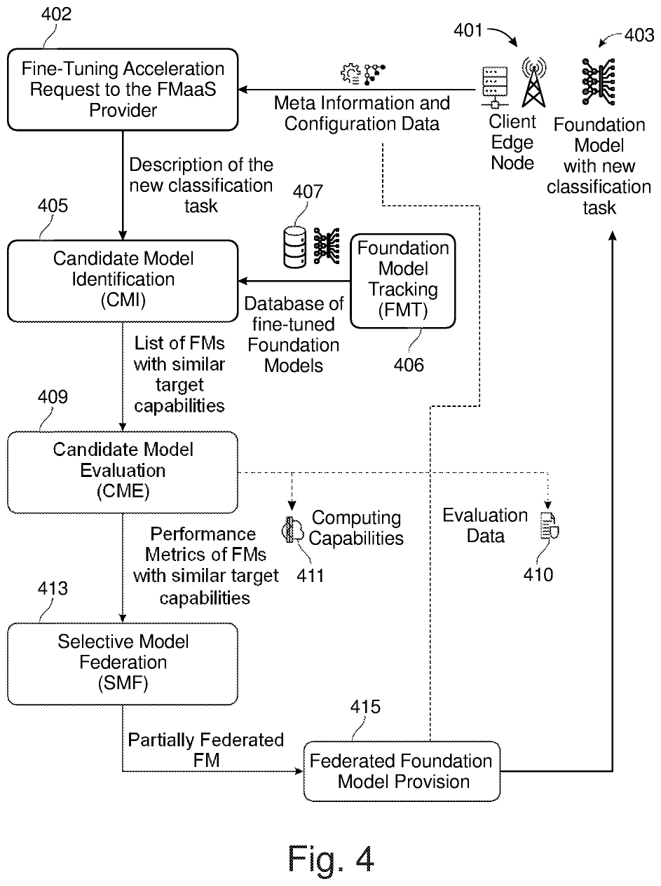

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 5. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in code 900 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in code 900 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 1050 is depicted. As shown, cloud computing environment 1050 includes one or more cloud computing nodes 1010 with which local computing devices used by cloud consumers, such as, for example, personal digital assistant (PDA) or cellular telephone 1054A, desktop computer 1054B, laptop computer 1054C, and/or automobile computer system 54N may communicate. Nodes 1010 may communicate with one another. They may be grouped (not shown) physically or virtually, in one or more networks, such as Private, Community, Public, or Hybrid clouds as described hereinabove, or a combination thereof. This allows cloud computing environment 1050 to offer infrastructure, platforms and/or software as services for which a cloud consumer does not need to maintain resources on a local computing device. It is understood that the types of computing devices 1054A-N shown in FIG. 6 are intended to be illustrative only and that computing nodes 1010 and cloud computing environment 1050 can communicate with any type of computerized device over any type of network and/or network addressable connection (e.g., using a web browser).

Referring now to FIG. 7, a set of functional abstraction layers provided by cloud computing environment 1050 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 1060 includes hardware and software components. Examples of hardware components include: mainframes 1061; RISC (Reduced Instruction Set Computer) architecture based servers 1062; servers 1063; blade servers 1064; storage devices 1065; and networks and networking components 1066. In some embodiments, software components include network application server software 1067 and database software 1068.

Virtualization layer 1070 provides an abstraction layer from which the following examples of virtual entities may be provided: virtual servers 1071; virtual storage 1072; virtual networks 1073, including virtual private networks; virtual applications and operating systems 1074; and virtual clients 1075.

In one example, management layer 1080 may provide the functions described below. Resource provisioning 1081 provides dynamic procurement of computing resources and other resources that are utilized to perform tasks within the cloud computing environment. Metering and Pricing 1082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1083 provides access to the cloud computing environment for consumers and system administrators. Service level management 1084 provides cloud computing resource allocation and management such that required service levels are met. Service Level Agreement (SLA) planning and fulfillment 1085 provide pre-arrangement for, and procurement of, cloud computing resources for which a future requirement is anticipated in accordance with an SLA.

Workloads layer 1090 provides examples of functionality for which the cloud computing environment may be utilized. Examples of workloads and functions which may be provided from this layer include: mapping and navigation 1091; software development and lifecycle management 1092; virtual classroom education delivery 1093; data analytics processing 1094; transaction processing 1095; and a AI model provider (AIP) 1096 that selects and provides the second artificial intelligence models in accordance with the present subject matter.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

What is claimed is:

1. A method in a distributed system comprising first computer systems that are configured to connect to at least one second computer system of the distributed system, the method comprising:
determining, by a specific first computer system of the first computer systems, a need to fine-tune a first artificial intelligence model for performing a specific task;
performing a federated learning for a set of trained second artificial intelligence models for generating a combined artificial intelligence model, the set of trained second artificial intelligence models being configured to perform the specific task, each second artificial intelligence model having a structure that is at least a substructure of the first artificial intelligence model; and
using learnable parameters of the combined artificial intelligence model for fine-tuning, at the specific first computer system, the first artificial intelligence model.

2. The method of claim 1, further comprising:
selecting the set of second artificial intelligence models from a larger set of second artificial intelligence models based on the specific task.

3. The method of claim 1, the set of second artificial intelligence models being a subset of a larger set of second artificial intelligence models, wherein the set of second artificial intelligence models are described by model attributes, the method further comprising:
evaluating the model attributes for the larger set of second artificial intelligence models;
storing, in a database, records representing the larger set of second artificial intelligence models, the records comprising the evaluated model attributes;
indexing the database using one or more of the model attributes, resulting in an index; and
using the index and the specific task for identifying the set of trained second artificial intelligence models.

4. The method of claim 3, wherein the evaluating and the storing are performed on a periodic basis.

5. The method of claim 3, further comprising:
logging changes to the database in a log file, using the log file for tracking changes to the database; and
using the index based on the tracked changes.

6. The method of claim 5, wherein using the index comprising:
evaluating at least part of the model attributes for the first artificial intelligence model;
defining a query based on the evaluated model attributes;
querying the database using the index and the defined query;
receiving a response of the query comprising candidate second artificial intelligence models; and
selecting the set of trained second artificial intelligence models from the candidate second artificial intelligence models using a selection criterion.

7. The method of claim 6, wherein the candidate second artificial intelligence models have a matching level with the defined query that is higher than a minimum threshold.

8. The method of claim 7, the threshold being defined by the specific first computer system.

9. The method of claim 6, the selection criterion requiring an inference accuracy of the candidate second artificial intelligence model that is better than an accuracy threshold.

10. The method of claim 1, the federated learning being performed by aggregating learnable parameters of the set of second artificial intelligence models.

11. The method of claim 10, wherein the aggregating is done using a weighted sum, wherein weights are inference accuracies of the set of second artificial intelligence models, respectively.

12. The method of claim 1, wherein the first computer system has an amount of processing resources that is smaller than the processing resources of the at least one second computer system.

13. The method of claim 1, the distributed system being a wireless communication system, wherein the first computer systems are multi-access edge computing (MEC) nodes and the at least one second computer system is a cloud system.

14. The method of claim 1, wherein each artificial intelligence model is a foundation model.

15. A computer program product for a distributed system comprising first computer systems which are configured to connect to at least one second computer system of the distributed system, the computer program product comprising a computer-readable storage medium having computer-readable program code embodied therewith, the computer-readable program code configured to perform a method comprising:
determining, by a specific first computer system of the first computer systems, a need to fine-tune a first artificial intelligence model for performing a specific task;
performing a federated learning for a set of trained second artificial intelligence models for generating a combined artificial intelligence model, the set of trained second artificial intelligence models being configured to perform the specific task, each second artificial intelligence model having a structure that is at least a substructure of the first artificial intelligence model; and
using learnable parameters of the combined artificial intelligence model for fine-tuning, at the specific first computer system, the first artificial intelligence model.

16. A computer system for a distributed system comprising first computer systems which are configured to connect to at least one second computer system of the distributed system, the computer system comprising one or more computer-readable storage media configured to store computer program code, and one or more computer processors configured to access said computer program code and operate as instructed by said computer program code, said computer program code being configured for:
determining a need to fine-tune a first artificial intelligence model for performing a specific task;
performing a federated learning for a set of trained second artificial intelligence models for generating a combined artificial intelligence model, the second artificial intelligence models being configured to perform the specific task, each second artificial intelligence model having a structure which is at least a substructure of the first artificial intelligence model; and
using learnable parameters of the combined artificial intelligence model for fine-tuning the first artificial intelligence model.

17. The computer system of claim 16, being a first computer system of the first computer systems.
